(19) United States
(12) Patent Application Publication
(10) Pub. No.: US 2003/0068006 A1
(43) Pub. Date: Apr. 10, 2003

(54) Computed tomography apparatus and X-ray generator device therefor

(75) Inventors: Walter Beyerlein, Bubenreuth (DE); Robert Heiter, Fuerth (DE); Karsten Schmitt, Erlangen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/268,181

(22) Filed: Oct. 10, 2002

(30) Foreign Application Priority Data
Oct. 10, 2001 (DE) 10150048.3

(51) Int. Cl. H05G 1/60

(52) U.S. Cl. 378/15

(57) ABSTRACT

As apparatus components, a computed tomography apparatus has at least a rotating X-ray generator and an operating unit, between which data can be exchanged wirelessly via a radio link on the basis of radio waves or microwaves. A rotating X-ray generator device of a computed tomography apparatus has a generator unit and a transmission and/or reception device allocated thereto for transmitting and/or receiving electromagnetic broadcast signals. This allows a wireless data transmission while avoiding wiper rings. The bluetooth standard or a GSM or UMTS standard can be employed as standards.

### BACKGROUND OF THE INVENTION

1. Field of the Invention

The present invention is directed to a computed tomography apparatus of the type having a number of apparatus components, one of which is a rotating X-ray radiator and another of which is an operating unit. The present invention also is directed to a rotatable X-ray radiator device for a computed tomography apparatus having a voltage and current generator unit.

2. Description of the Prior Art

In a known computer tomography apparatus, an X-ray exposure system, particularly an X-ray source and/or an X-ray detector, moves around the patient under examination on a gantry. It is known to transmit control data voltage and to the generator or the X-ray source, or measured data from the X-ray detector, from or to a stationary or non-moving apparatus component via one or more wiper rings, particularly from an operating unit or to an image evaluation unit. Such wiper rings, which produce a wiping electrical contact, are complex and susceptible to malfunction.

### SUMMARY OF THE INVENTION

An object of the present invention is to simplify the data transmission in a computed tomography apparatus and to reduce the sensitivity to disruption.

In a computed tomography apparatus of the type initially described, this object is inventively achieved in that at least the voltage and current generator and the operating unit exchange data by wirelessly communicating with one another by free space broadcasting via a transmission path which is a radio wave (RF) link or a microwave link, and, optionally, one of these two components wireless communicates with other apparatus components or, optionally, these other apparatus components wirelessly communicate one another.

The carrier frequency of the electromagnetic radio link is in the radiofrequency range, particularly in the range from 100 MHz through 10 GHz.

As a result of this wireless data transmission, the data communication between apparatus components is less susceptible to disturbance than in a system utilizing electrical contacts. Moreover, radio standards as well as appertaining transmission and reception modules that are economical and simple to handle are available for the data transmission. Standards for such so-called “wireless modules” include the DECT standard with an approximately 20 kB/s transmission rate, what is referred to as Home RF, wireless LAN, as well as to as the bluetooth standard with a transmission rate of 721 kBits/s. Moreover, the GSM (Global System for Mobile Communication) standard as well as an arbitrary UMTS (Universal Mobile Transmission Standard) are also available for transmission over longer distances. Wireless modules of this type are described, for example, in a the article “Wireless-Module im Industrie-einzatz,” by Pernsteiner in the periodical “Elektronik”, 2/2001, pp. 82-89.

The invention is thereby based on the use of such wireless transmission standards within a computed tomography apparatus, i.e. for the component communication. This is based, among other things, on the recognition that such standards can be dependably employed and without jeopardizing patients, i.e a recognition that the high-voltages that thereby arise do not produce any disruption of the wireless transmission.

In addition to these advantages, the computed tomography apparatus of the invention also has the advantage that the apparatus components can be freely varied in terms of location within the range of the radio waves or microwaves and disturbing transmission lines (“stumbling blocks”) can be eliminated.

A particular advantage also is achieved that wiper rings for the transmission of the control data from the operating unit to the X-ray generator can be eliminated. The sensitivity to disruption is advantageously enhanced as a result.

The apparatus components preferably each include a transmission and/or reception device for the transmission and/or reception of electromagnetic broadcast signals with which a data value, particularly a control command, an error message, a reply or a measured value, can be transmitted between the apparatus components. For example, the operating unit as well as the X-ray generator respectively have a transmission and/or reception device with which a control command can be transmitted from the operating unit to the X-ray generator.

The transmission and/or reception devices thereby preferably all operate according to an identical standard, particularly with employment of a uniform data format and/or a uniform transmission interface. The standard, for example, is one of the standards cited above.

The advantage resulting from this feature is that all apparatus components can universally communicate with one another. In a known examination apparatus with hardwired transmission between apparatus components, different wirings are often required for different medical applications or examinations. Such individual wirings can be eliminated with the inventive, wireless transmission between the apparatus components.

In a preferred embodiment, one of the other apparatus components is a patient support mechanism. This can have a separate transmission and/or reception device allocated to it with which control commands can be communicated from the operating unit to the patient support mechanism.

Advantageously, the examination apparatus of the invention also has a radio link to a patient data administration system.

In a further embodiment, one of the other apparatus components is a converter module via which apparatus data can be transmitted to or from a wide-area network. In particular, the wide-area network is the Internet or a mobile radiotelephone network. The converter module thus represents an interface from the apparatus-internal, wireless near-range transmission to communication over long distances, for example via a mobile radiotelephone network (GSM or UMTS). For example, a connection to a service center can be set up in this way. To this end, the examination apparatus is fashioned such that contact to a service center via mobile radiotelephone is automatically started in the event of an error. The contact is limited either to the information that an error has occurred, or measured data that allow or support an error search are additionally transmitted.

In an X-ray generator device of the type initially described, the above object is inventively achieved by a transmission and/or reception device allocated to the generator unit for the transmission and/or reception of electromagnetic broadcast signals.

High voltage and high currents are handled in the X-ray generator. Among other things, the invention is based on the recognition that a radio link from or to the X-ray generator can be operated with an adequate signal-to-noise ratio relative to the electromagnetic fields arising from the alternating voltages and alternating currents.

In particular, control data for the setting or the operation of the X-ray generator can be transmitted via the broadcast signals.

In a preferred embodiment of the X-ray generator device includes a service module and/or test field module allocated to the generator unit that is capable of implementing a test function with respect to the proper operation of the generator unit.

The transmission and/or reception device and the service and/or test field modules are, in particular, permanently allocated to the generator unit or form a structural unit with it, for example on the basis of a common housing or housings that are rigidly connected to one another.

Preferably, a result value of the test function can be transmitted to a computer external from the generator via the transmission and/or reception device.

In a rotating X-ray generator device, the combination of a transmission and/or reception device with a service and/or test field module has the particular advantage that test functions can be implemented during operation of the computed tomography apparatus. As a result, errors can be detected with more specificity, as well as faster and closer to real time than in a conventional arrangement wherein a data recorder merely co-rotates with the X-ray generator and the data registered therewith are read out after the actual operation and with the apparatus in a standstill condition and are evaluated by a computer external from the generator.

The transmission and/or reception device can, for example, transmit the result of the test implemented by the service and/or test field module directly to an evaluation unit, particularly to the operating unit or to a display unit, where the results can be displayed for the user. The data generated or acquired by the service and/or test field module preferably are suppliable to the evaluation unit, particularly the computer, via the transmission and/or reception device during operation of the X-ray generator, preferably continuously.

The X-ray generator device can include a measured value sensor for measuring a generator operating parameter and a processor for the implementation of the test function dependent on the generator operating parameter. A memory can be present for the intermediate storage of the data measured by the measured value sensor.

The allocation a service and/or test field module to the generator unit for implementing a test function with respect to the proper operation of the generator unit is advantageous regardless of whether the generator unit is equipped with a wireless communication connection or with a wiper ring. The invention therefore encompasses an X-ray generator device having an arbitrary type of data interface and having the described service and/or test field module.

### DESCRIPTION OF THE DRAWINGS

FIG. 1 is an exemplary embodiment of a computed tomography apparatus of the invention.

FIG. 2 is an exemplary embodiment of an X-ray generator device of the invention.

### DESCRIPTION OF THE PREFERRED EMBODIMENTS

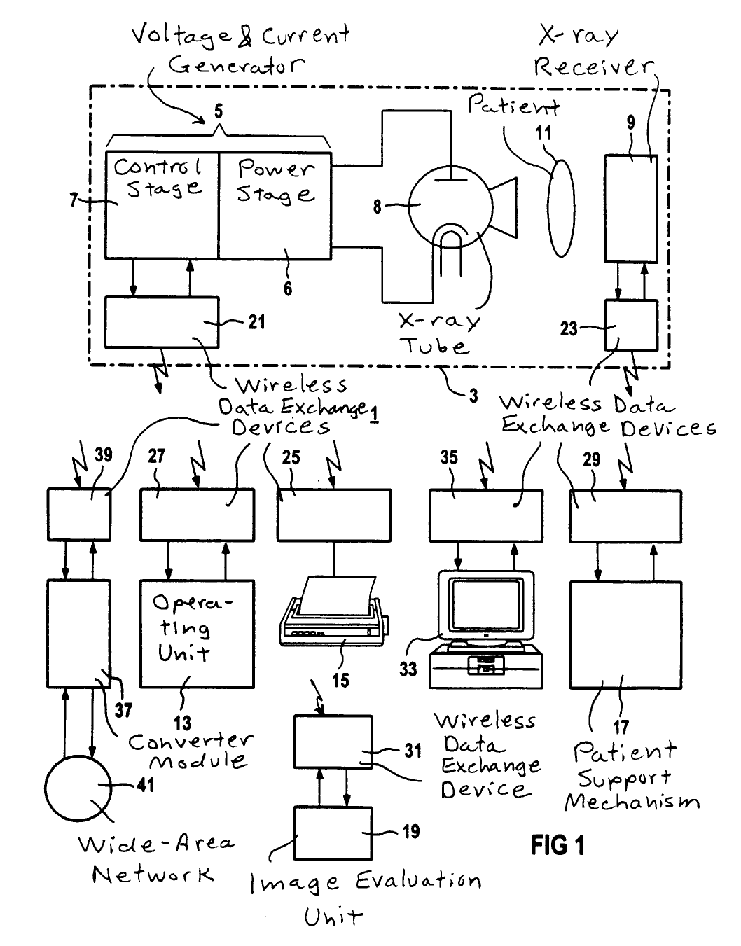

FIG. 1 shows a computed tomography apparatus 1 of the invention having a number of apparatus components that are only schematically shown as assemblies and, in particular, not in true position. The computed tomography apparatus 1 includes an X-ray exposure system 3 with a voltage and current generator 5 for driving an X-ray tube 8. The voltage and current generator 5 includes a power stage 6 and a control stage 7 as function groups. During transirradiation of a patient 11, the X-rays emitted by the X-ray tube 8 are detected by an imaging X-ray receiver 9. In addition to the X-ray generator 5 and the X-ray receiver 9, an operating unit 13 operate by attending personnel, a data printer 15, a patient support mechanism 17 provided for seating the patient 11 and an image evaluation unit 19 for the evaluation of the signals measured by the X-ray receiver 9 are present as further electrical apparatus components. The generator 5 and the appertaining X-ray tube 8 successively rotate around the patient 11 together with the X-ray receiver 9 through various slices (scan mode or spiral mode) approximately parallel to the plane of the drawing until enough raw data for a subsequent image reconstruction are available.

These apparatus components are respectively equipped with a wireless signal exchange devices 21, 23, 25, 27, 29 and 31, which can be a transmission device, a reception device or a transmission/reception device.

By employing identical wireless data exchange devices 21, 23, 25, 27, 29, 31 for all apparatus components, conventional transmission lines for exposure data of the X-ray receiver 9 and/or transmission line for control commands or answerbacks from the control console or the operating unit 13 to the generator 5 can be eliminated. For example, wireless data exchange devices 21, 23, 25, 27, 29, 31 can be devices referred to as “wireless modules”, particularly according to the DECT standard or according to the bluetooth standard.

The computed tomography apparatus 1 according to FIG. 1 also includes a patient data administration system 33 to which a separate wireless date exchange device 35 of the same type is allocated. A converter module 37 having a likewise separate but identical wireless data exchange device 39 is also present with which a link to a wide-area network 41, for example to the Internet or to a mobile radiotelephone network, can be set up. In this version, the computed tomography apparatus 1 is especially suited for a long-distance transmission of generator data. To this end, for example, the generator software in the control part 7 is expanded by test and service routines. According to the version shown in FIG. 1, a wireless near-range transmission to the converter module 37 ensues first. A further transmission to a service center then ensues, for example, via the Internet or the mobile radiotelephone network.

Alternatively, the wireless data exchange device 21 of the X-ray generator 5 or one of the other wireless data exchange devices 23, 25, 27, 29, 31, 35, 39 is fashioned such that a data transmission directly via the mobile radiotelephone network is possible, for instance to the service center.

In the event of an apparatus error, an automatic triggering of a service alarm in the remote service center can ensue by means of suitable software in both versions.

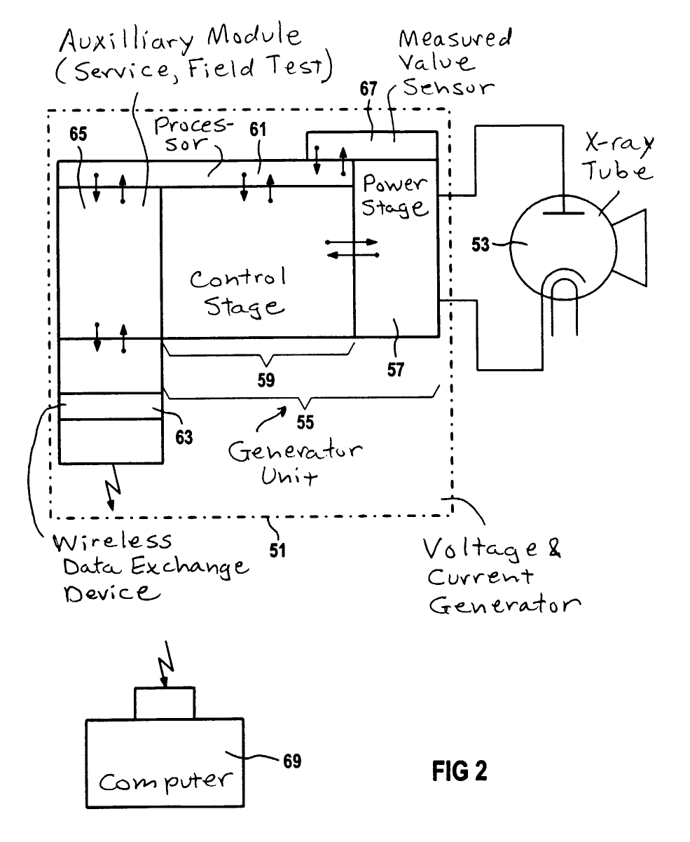

The exemplary embodiment of FIG. 2 shows a voltage and current generator device 51 of the invention with an X-ray tube 53 and a generator unit 55 for the drive thereof. The generator unit 55 has a power stage 57 and a control stage 59. Generator software that acts on the control hardware (regulator, A/D converter, D/A converter) is stored in the control stage 59. A processor that is in data exchange with the control part 59 is present for the data processing.

The generator unit 53 is expanded both by a wireless data exchange device 63 for transmitting and/or receiving electromagnetic broadcast signals as well as by an auxiliary module 65, which is a service and/or field test module, for the implementation of a test function with respect to the proper operation of the generator unit. The auxiliary module 65 uses the processor 61 for data processing in common with the control part 59.

The auxiliary 65 can be realized, for example, only in the form of an expansion of the control software, i.e. its embodiment as a service and/or test module is as a software module with additional functions, particularly test functions.

A measured value sensor 67 that is likewise in data exchange with the processor 61 is present for measuring a generator operating parameter, for example the tube voltage or the tube current. The test functions stored in the service and/or field test software are implemented or calculated in the processor 61. A result value of the test function can be transmitted via the wireless data exchange device 63 to a computer 69 external from the generator.

The service and/or field test software enables the execution of the test function either in the test field after final assembly during manufacture or later during ongoing operations. Corresponding communication software controls the transmission of the data values and measured values via the wireless data exchange device 63. A further evaluation of the data is then possible in the external computer 69. For example, the computer 69 is a service PC or a test computer.

The software forming the service and/or test module as the auxiliary 65 is, in particular, designed such that an automatic service call via the wireless data exchange device 63 is triggered given a poor function or a malfunction of the X-ray generator device 51. To this end, the wireless data exchange device 63 is fashioned, for example, such that it can enter into direct contact with a mobile radiotelephone network (GSM, UMTS). Alternatively, an Internet connection can be set up.

Although modifications and changes may be suggested by those skilled in the art, it is the intention of the inventors to embody within the patent warranted hereon all changes and modifications as reasonably and properly come within the scope of their contribution to the art.

We claim as our invention:

1. A computed tomography apparatus comprising:
a plurality of apparatus components, including a rotating X-ray generator and an operating unit for said rotating X-ray generator; and
each of said X-ray generator and said operating unit having a wireless data exchange device, selected from the group consisting of microwave devices and radio devices, allowing wireless data exchange via free space between said operating unit and said X-ray generator.

2. A computed tomography apparatus as claimed in claim 1 wherein at least one other of said apparatus component has a wireless data exchange device for wirelessly exchanging data with at least one of said X-ray generator and said operating unit.

3. A computed tomography apparatus as claimed in claim 2 wherein each of said wireless data exchange devices is a standardized device operating according to a wireless transmission standard, and wherein all of said wireless transmission devices operate according to the same wireless transmission standard.

4. A computed tomography apparatus as claimed in claim 2 wherein at least two of said apparatus components, in addition to said X-ray generator and said operating unit, each have a wireless data exchange device for wireless data exchange between said two of said apparatus components.

5. A computed tomography apparatus as claimed in claim 4 wherein each of said wireless data exchange devices is a standardized device operating according to a wireless transmission standard, and wherein all of said wireless transmission devices operate according to the same wireless transmission standard.

6. A computed tomography apparatus as claimed in claim 1 wherein said wireless data exchange device comprises a device for at least one of transmission of electromagnetic broadcast signals and reception of electromagnetic broadcast signals, wherein said electromagnetic broadcast signals include at least one data value selected from the group consisting of a control command, an error message, a reply, and a measured value.

7. A computed tomography apparatus as claimed in claim 1 wherein said plurality of apparatus components includes a patient support mechanism having a wireless data exchange device, allowing wireless data exchange between said patient support mechanism and at least one of said X-ray generator and said operating unit.

8. A computed tomography apparatus as claimed in claim 1 further comprising a communication unit for establishing a radio connection to a patient data administration system located remotely from said communication unit.

9. A computed tomography apparatus as claimed in claim 1 wherein said plurality of apparatus components includes a converter module adapted to exchange data via a wide-area network.

10. A computed tomography apparatus as claimed in claim 9 wherein said converter module is adapted for data exchange with the Internet, as said wide area network.

11. A computed tomography apparatus as claimed in claim 9 wherein said converter module is adapted for data exchange with a mobile radiotelephone network, as said wide area network.

12. A computed tomography apparatus as claimed in claim 1 wherein said wireless data exchange devices operate according to the bluetooth standard.

13. A computed tomography apparatus as claimed in claim 1 wherein said wireless data exchange devices operate according to a standard selected from the GSM standard and the UMTS standard.

14. A rotatable X-ray radiator device for use in a computed tomography apparatus, comprising:
an X-ray tube;
a voltage and current generator unit connected to said X-ray tube for generating voltages and currents for driving said X-ray tube; and
a wireless data exchange device connected to said generator unit for at least one of transmission of electromagnetic broadcast signals relating to operation of said generator unit and reception of electromagnetic broadcast signals relating to operation of said generator unit.

15. A rotatable X-ray radiator device as claimed in claim 14 further comprising a module, selected from the group consisting of service modules and field test modules, connected to said generator unit for implementing a test function relating to operation of said generator unit and for producing a test result supplied to said wireless data exchange module for transmission to a location remote from said generator unit.

16. A rotatable X-ray radiator device as claimed in claim 15 wherein said module comprises a measured value sensor for measuring an operating parameter relating to said operation of said generator, and a processor supplied with said operating parameter measured by said measured value sensor for implementing said test function dependent on said operating parameter.

17. A rotatable X-ray radiator device as claimed in claim 15 wherein said wireless data exchange device is adapted for transmitting said test result to a computer at a location remote from said generator unit.
